(19) United States
(12) Patent Application Publication
(10) Pub. No.: US 2026/0360065 A1
(43) Pub. Date: Nov. 12, 2026

(54) GENERATING DIGITAL VIDEOS WITH MULTIPLE SHOTS

(71) Applicant: Adobe Inc., San Jose, CA (US)

(72) Inventors: Tobias Hinz, Ulm (DE); Ozgur Kara, Urbana, IL (US); Krishna Kumar Singh, San Jose, CA (US); Feng Liu, Portland, OR (US); Duygu Ceylan Aksit, London (GB)

(73) Assignee: Adobe Inc., San Jose, CA (US)

(21) Appl. No.: 19/202,866

(22) Filed: May 8, 2025

(51) Int. Cl. G06T 13/80; G06F 40/284; G06T 5/50; G06T 5/70; G06T 11/00; G06V 10/774

(52) U.S. Cl. CPC G06T 13/80; G06T 5/50; G06T 5/70; G06T 11/00; G06V 10/774; G06F 40/284; G06T 2200/24; G06T 2207/20081; G06T 2207/20084

(57) ABSTRACT

Techniques for generating digital videos with multiple shots are described. A processing device may obtain one or more text prompts describing a set of shots in a digital video. The processing device may then generate the digital video using a machine-learning model based on a sequence of tokens as corresponding to the set of shots and a transition token corresponding to a transition between the set of shots. The processing device may then present the digital video for display in a user interface.

### BACKGROUND

Digital video is configured as a sequence of digital video frames that are usable to exhibit motion between digital video frames. Respective digital video frames of the digital video typically include attributes, e.g., one or more of a foreground subject that overlays a background, an action of the foreground subject, and a capture perspective of the foreground subject.

### SUMMARY

Techniques are described for generating digital video with multiple shots from one or more text prompts. In one or more examples, a processing device uses a sequence of tokens, as well as a transition token, to generate a digital video with multiple shots. The computing device introduces the transition token as input to a video generation model to differentiate between different shots when generating the digital video with multiple shots. These techniques enable granular multi-shot digital video generation, such that the processing device generates respective shots according to instructions or criterion for the respective shots identified in the text prompts without increasing the use of computational resources, including processing resources, memory resources, and power resources.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities, thus reference is made interchangeably to single or plural forms of the entities in the discussion.

FIG. 1 is an illustration of a digital medium environment in an example implementation that is operable to employ techniques described herein for generating a digital video with multiple shots.

FIG. 2 depicts a system as an example implementation of a machine-learning model that is operable by a device (e.g., a computing device or a device in a service provider system) to employ techniques described herein for generating a digital video with multiple shots.

FIG. 3 depicts a system as an example implementation of joint attention in a machine-learning model that is operable by a device (e.g., a computing device or a device in a service provider system) to employ techniques described herein for generating a digital video with multiple shots.

FIG. 4 depicts a system as an example implementation of a local attention mask in a machine-learning model that is operable by a device (e.g., a computing device or a device in a service provider system) to employ techniques described herein for generating a digital video with multiple shots.

FIG. 5 depicts a procedure for generating a dataset in an example implementation of digital video generation, which is performable by a computing device to generate a digital video with multiple shots.

FIG. 6 depicts a procedure for various techniques for collecting a dataset in an example implementation of digital video generation, which is performable by a computing device to generate a digital video with multiple shots.

FIG. 7 depicts a procedure for post processing of a dataset in an example implementation of digital video generation, which is performable by a computing device to generate a digital video with multiple shots.

FIG. 8 depicts a visualization of displaying digital video content that is generated based on one or more text prompts.

FIG. 9 is a flow diagram depicting an algorithm as a step-by-step procedure in an example implementation of digital video generation, which is performable by a computing device to generate a digital video with multiple shots.

FIG. 10 is a flow diagram depicting an algorithm as a step-by-step procedure in an example implementation of digital video generation, which is performable by a service provider system to generate a digital video with multiple shots.

FIG. 11 shows an example of a guided diffusion model according to aspects of the present disclosure.

FIG. 12 shows an example of a U-Net according to aspects of the present disclosure.

FIG. 13 shows an example of a method for conditional media generation according to aspects of the present disclosure.

FIG. 14 shows a diffusion process according to aspects of the present disclosure.

FIG. 15 shows a flow diagram depicting an algorithm as a step-by-step procedure for training a machine-learning model according to aspects of the present disclosure.

FIG. 16 shows an example of a method for training a diffusion model according to aspects of the present disclosure.

FIG. 17 shows an example of a computing device according to aspects of the present disclosure.

### DETAILED DESCRIPTION

### Overview

Conventional techniques employed by processing devices, which may also be referred to as computing devices, to generate digital videos from a text prompt include generating a digital video of a single shot that is representative of the text prompt. A shot includes a single, uninterrupted set of frames of the digital video with continuous motion. The conventional techniques lack a capability to generate digital videos with multiple shots, referred to as multi-shot digital videos, with discrete transitions between the different shots. The shots in a multi-shot digital video are separated by an instantaneous change in attributes of respective digital video frames of the multi-shot digital video. Further, even if the conventional techniques could generate a digital video with multiple shots, a computing device implementing the conventional techniques is unable to control parameters of the different shots in the digital video, such as a duration and content of the different shots in the digital video. Thus, the conventional techniques for generating digital video from a text prompt either are unable to generate a digital video with multiple different shots or are unable to control a granularity for generating the digital video with multiple different shots, such that the digital video includes shots that are not an accurate representation of the text prompt and/or do not align with instructions provided in the text prompt.

To address these and other technical challenges, techniques are described to generate a digital video with multiple different shots from one or more text prompts at a per-shot granularity. To do so, a computing device is configured to implement an adapted (e.g., fine-tuned, trained) video generation model configured to generate multi-shot digital video with consistent subjects and backgrounds across different shots, while providing for granular control over respective shots. For example, the computing device can collect training data by converting single shot digital video data into multi-shot digital video data. The computing device can use the training data and can incorporate one or more transition tokens to adapt a video generation model to generate a new, unseen multi-shot digital video from one or more shot-specific text prompts. The computing device receives the text prompts, such as via an input field displayed at a user interface of the computing device. The computing device provides a sequence of tokens that includes tokens representative of the multi-shot digital video, including noise tokens, tokens representative of the text prompts, and the transition tokens as input to the adapted video generation model. The adapted video generation model processes the sequence of tokens to generate a multi-shot digital video with different shots representative of respective shot-specific prompts. The computing device can display the multi-shot digital video at the user interface of the computing device. By implementing the digital video generation techniques, the computing device can transform text prompts into a multi-shot digital video and with a relatively high level of detail, accuracy, and efficiency (e.g., greater than a threshold value) when compared with conventional techniques.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment for Generating Digital Video Content

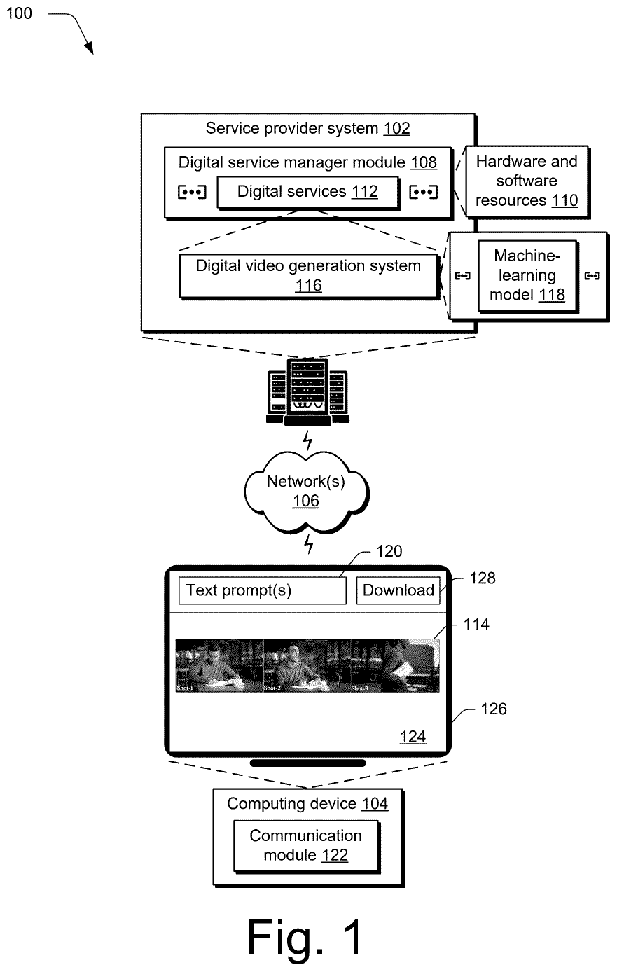

FIG. 1 is an illustration of a digital medium environment 100 in an example implementation that is operable to employ techniques described herein for generating a digital video with multiple shots. The digital medium environment 100 includes a service provider system 102 and a computing device 104, which may also be referred to as a processing device. In one or more implementations, the computing device 104 and the service provider system 102 may be communicatively coupled via one or more networks 106. An example of the networks 106 is the Internet, although the computing device 104 and the service provider system 102 may be communicatively coupled using one or more different connections or different networks (e.g., wired or wireless networks) in various implementations.

A service provider system 102 may include or may be implemented by one or more devices, such as application servers, database servers, web servers, and file servers, among other example devices, to manage different aspects of digital data services and storage. The devices included in or implementing the service provider system 102 may be referred to as server devices. The computing device 104 and the server devices in the service provider system 102 may exchange instructions, signaling, messages, or other communications via the networks 106, such as over the air via a wireless connection or via a physical, wired connection. For example, the server devices may transmit signaling to the computing device 104 that includes instructions that cause the computing device 104 to perform various tasks or actions, including displaying or outputting information and/or performing one or more processing tasks. The computing device 104 may receive and decode the signaling and may perform the actions according to the instructions.

Although the service provider system 102 is depicted in the digital medium environment 100 as being separate from the computing device 104, in one or more implementations, an entirety, or various portions of the service provider system 102 may be implemented at or by the computing device 104. In at least one implementation, for example, at least a portion of the service provider system 102 may be implemented by an application of the computing device 104 and/or using various resources of the computing device 104, such as hardware resources, an operating system, firmware, and so forth. Alternatively, or additionally, the service provider system 102 may be implemented by server-based storage resources, processing resources, and so on of devices other than the computing device 104. For example, at least a portion of the service provider system 102 may be implemented using a third-party service, such as a web services platform that provides one or more hardware and/or other computing resources to support provision of services by web service providers.

A computing device 104 that implements the digital medium environment 100 is configurable in a variety of ways. A computing device 104, for example, may be configurable as a desktop computer, a laptop computer, a mobile device (e.g., assuming a handheld configuration such as a tablet or mobile phone), an internet of things (IoT) device, a wearable device (e.g., a smart watch, a ring, or smart glasses), an augmented reality and/or virtual reality device (e.g., the smart glasses), a server, and so forth. Thus, a computing device 104 may range from full resource devices with substantial memory and processor resources to low-resource devices with reduced memory and/or processing resources. Although in instances in the following discussion reference is made to a computing device 104 in the singular, a computing device 104 may also be representative of multiple different devices.

The service provider system 102 may implement a digital service manager module 108 to allocate hardware and software resources 110 of the service provider system 102 to one or more digital services 112. The digital service manager module 108 may be implemented as hardware or software functionality of the service provider system 102, including as instructions or code, as well as one or more processors, buses, or other hardware components configured to execute the instructions or code to implement the digital services 112. Example digital services 112 include, but are not limited to, a digital video generation service that provides for transformation of text or images into digital video content 114, editing services that modify the generated digital video content 114, image animation services, motion customization services, real-time digital video content streaming services that provide broadcasting and interaction with digital video content 114, and virtual reality and augmented reality digital video content services that immerse viewers in interactive environments, among other examples.

The digital video content 114 includes, but is not limited to, digital video data including digital frames and audio data, digital image data, text data, or augmented reality or virtual reality digital data, among other examples. A digital frame in a digital video is an image that, when combined in sequence with other frames, is representative of motion in the digital video. The digital frames in the digital video can have one or more attributes, including one or more of a foreground subject (e.g., character, object) of a digital frame, a background of a digital frame, an action of the foreground subject of the digital frame, or a capture perspective of the digital frame. The digital video can include multiple different shots, referred to as a multi-shot digital video. A shot is defined as a smallest segment of a digital video including a single, uninterrupted set of digital frames with continuous motion. Each shot is characterized by dynamic elements, such as the attributes of the digital frames, including the foreground subject, background setting, subject actions, and camera movement.

A multi-shot digital video is a digital video composed of multiple individual shots, each individual shot is separated by a cut, which is an instantaneous change in the dynamic elements. For example, an N-shot digital video, V, can be represented as

$$V = {s}_{1}^{{K}_{1}} , … , {s}_{N}^{{K}_{N}}$$

where each shot

$${s}_{i}^{{K}_{i}}$$

is a set of Kᵢ frames,

$${s}_{i}^{{K}_{i}} = \{ {f}_{1} , … , {f}_{{K}_{i}} \} ,$$

with each frame fⱼ∈ [symbol] ^{C×H×W} representing an image with channel, C, height, H, and width, W. In some examples, the multi-shot digital video features a single foreground subject, such as a human or other object.

The service provider system 102 and/or a computing device 104 implements a digital video generation system 116 to provide for generation of digital video content 114. The digital video generation system 116 deploys (e.g., uses, implements) one or more machine-learning models 118, which may also be referred to as artificial intelligence models or algorithms, to generate the digital video content 114. Although the digital video generation system 116 and the machine-learning models 118 are illustrated as being implemented by (e.g., deployed at) the service provider system 102, the digital video generation system 116 and the machine-learning models 118 may additionally, or alternatively, be implemented by the computing device 104. The machine-learning models 118 may include large language models to analyze and interpret a text prompt 120 to extract semantic meaning, context, and intent from the text prompt 120. The digital video generation system 116 uses the semantic meaning, context, and intent to manage generation of digital video content 114.

The text prompt 120 is a natural language description or instruction that guides the machine-learning models 118 in generating or manipulating visual content. The text prompt 120 can include characters, strings (e.g., words, phrases, or sentences), and numbers that describe an intended output of the machine-learning models 118. For example, the text prompt 120 may include attributes to include in the digital video content 114 generated by the machine-learning models 118, including subjects or objects, scenes, colors, styles, or actions to be depicted in the digital video content 114. In some examples, the text prompt 120 can include a compilation of different text prompts or different portions of a text prompt that indicate different attributes (e.g., descriptors, characteristics, features) of respective shots in a multi-shot digital video. The text prompt 120 can include or define a content of the respective shots (e.g., one or more actions to be performed by a subject in the different shots), as well as a duration and/or numerical quantity of shots to include in the multi-shot digital video.

For example, the text prompt 120 can include a string value “A man sketches in a notebook at a quiet café, his hand moving quickly across the page. He pauses, looking up thoughtfully before continuing his drawing. Later, the man steps outside, his notebook tucked under his arm as he takes in the city around him.” A first shot of a digital video content generated from the example string value can depict a man sketching in a notebook. A second shot of the digital video content generated from the example string value can include a man looking up from the notebook. A third shot of the digital video content generated from the example string value can include a man walking outside with the notebook under his arm.

The machine-learning models 118 may additionally, or alternatively, include diffusion models (e.g., diffusion transformers (DiTs), latent diffusion models) that are trained to remove noise from one or more video tokens, also referred to as visual tokens or noise tokens, to generate the digital video content 114. Diffusion models generate realistic data by learning to reverse a noise-adding process. During a training process, data is progressively noised over multiple time steps, and the machine-learning models 118 learns to denoise the data step by step. For example, the machine-learning models 118 start from data representative of true noise ϵ~N(0, I). The machine-learning models 118 obtains a noisy version

$${x}_{i}^{( t )}$$

of the data at timestep t by adding scaled noise

$${x}_{i}^{( t )} = \sqrt{{α}_{t}} {x}_{i} + \sqrt{1 - {α}_{t}} ϵ ,$$

where αₜ controls the noise level. The training loss function,

$${ℒ}_{diffusion} ( θ ) = {𝔼}_{{x}_{i} , ϵ , t} {‖ ϵ - {ϵ}_{θ} ( {x}_{i}^{( t )} , t ) ‖}^{2} ,$$

minimizes the difference between the true noise ϵ and a prediction

$${ϵ}_{θ} ( {x}_{i}^{( t )} , t )$$

of the machine-learning models 118. The training loss function enables the machine-learning models 118 to reconstruct original data through reverse diffusion by predicting the noise.

A latent diffusion model is a type of machine-learning model 118 that combines autoencoder models and diffusion probabilistic models to generate digital content, including digital videos. Given an input video sample xᵢ~p_{data}(x) with dimensions xᵢ ∈ [symbol] ^{F×C×H×W}, a latent diffusion model can encode a digital video using a three-dimensional (3D) encoder, ε, resulting in a latent representation zᵢ∈ [symbol] ^{F′×C′×H′×W′}, where F′=F/fₜ, H′=H/fₛ, and W′=W/fₛ, with fₛ and fₜ being the spatial and temporal compression ratios, respectively. The latent diffusion model transforms the latent video representation into a sequence of N tokens for a DiT-based model, denoted as

$$f ( x ) = {\{ {\overline{x}}_{i}^{n} \}}_{n = 1}^{n = N} .$$

Each token

$${\overline{x}}_{i}^{n} ∈ {ℝ}^{D}$$

has a hidden dimension, D. The latent diffusion model performs patchification along the width, height, and frame depth, with patch sizes represented by fₚ_{_{w}}, fₚ_{ₕ}, and fₚ_{_{f}}, respectively. Patchification refers to a process of dividing a latent representation of digital image or video data (e.g., a compressed form of an original digital image or video data) into smaller, non-overlapping patches. Patchification reduces computational complexity by providing for a latent diffusion model to process the patches rather than the entire latent representation.

The service provider system 102 or a third-party service may train one or more diffusion models, including the machine-learning models 118, using supervised learning techniques, unsupervised learning techniques, and/or semi-supervised learning techniques, among other example training techniques. Supervised learning techniques include training a machine-learning model 118 using paired datasets of one or more concatenated video tokens, text tokens, and transition tokens and an expected output digital video content, where the machine-learning model 118 learns to map the input tokens (e.g., video tokens, text tokens, and/or transition tokens) to a corresponding expected digital video content. Unsupervised learning techniques include training a machine-learning model 118 using unlabeled datasets, where the machine-learning model 118 learns to identify and remove noise by detecting patterns and structures from digital video content data. Semi-supervised learning combines both supervised and unsupervised learning techniques, such as by using both labeled datasets, including input tokens and expected output digital video content, and unlabeled datasets, including digital video content data.

The digital video generation system 116 may implement attention mechanisms to provide for the machine-learning model 118 to capture dependencies (e.g., long-range dependencies) between digital video frames in the digital video content 114, as well as to enable generation of multiple different shots of a multi-shot digital video. For example, the digital video generation system 116 may use the attention mechanisms to provide for per-shot granularity and to enhance a quality and coherence of the digital video content 114. The attention mechanisms may enable a machine-learning model 118 to identify attributes relevant to different shots in digital video content 114 with multiple shots, identify relevant spatial and temporal features, maintain consistency across digital video frames and shots in the digital video content 114, process conditioning information, manage dependencies between subjects in the digital video content 114, and improve details (e.g., resolution) of the digital video content 114, among other examples. The conditioning information may include data or inputs that guide the generation of the digital video content 114, such as a text prompt 120, image inputs, or other contextual data that indicates information (e.g., characteristics, criterion, features, attributes) related to an output of the machine-learning model 118.

Attention mechanisms for diffusion models trained to perform digital video generation may include additional layers, referred to as self-attention layers, which provide for analyzing and processing information from different portions of individual video frames in the spatial dimension, as well as across sequences of digital video frames over time in the temporal dimension. The digital video generation system 116 implements the attention mechanisms to enable the machine-learning model 118 to capture relationships and patterns during generation of the digital video content 114 that span both the visual content of individual digital video frames in the digital video content 114 and how that content changes and evolves throughout the duration of the digital video content 114.

The attention mechanisms for diffusion models trained to generate digital videos with multiple shots include local attention masking. M asking includes replacing a portion of input data (e.g., the input tokens) with a defined token or value, referred to as a mask. Local attention masking includes controlling attention interactions for defined groups of input tokens. For example, a machine-learning model 118 implementing local attention masking can mask an attention matrix to ensure interactions occur for the defined groups of input tokens. The transition token attends to the tokens at the transition frames, while the machine-learning model 118 uses the video tokens and text tokens for self-attention.

The computing device 104 may implement a communication module 122 to exchange data and/or control signaling with the service provider system 102. The communication module 122 may be implemented at least partially in hardware and/or software at the computing device 104. The communication model 122 may be implemented by one or more antennas, memory, and processors configured to generate, transmit, receive, and/or process information (e.g., the data and/or the control signaling) exchanged between the service provider system 102 and the computing device 104. Additionally, or alternatively, the service provider system 102 may include a communication module that is implemented by one or more antennas, memory, and processors configured to generate, transmit, receive, and/or process the information exchanged between the service provider system 102 and the computing device 104.

In one or more implementations, the computing device 104 may receive one or more machine-learning models 118 from the service provider system 102 via the communication module 122, such as values of weights and biases that make up the machine-learning models 118. The service provider system 102 and/or a third-party service can train the machine-learning models 118 to generate the digital video content 114. The computing device 104 may receive the text prompt 120 at a user interface 124 presented at a display 126 of the computing device 104. The computing device 104 may generate text tokens and transition tokens from the text prompt 120 and may generate one or more video tokens that include noise. The computing device 104 may concatenate the text tokens, the video tokens, and the transition tokens to obtain a concatenated sequence of tokens. The computing device 104 can provide the concatenated sequence of tokens text tokens as input to the machine-learning models 118. The machine-learning models 118 may provide the digital video content 114 as output, and the computing device 104 may output the digital video content 114 via the user interface 124 at the display 126.

Additionally, or alternatively, the computing device 104 may transmit the text prompt 120 to the service provider system 102 via the communication module 122. The digital video generation system 116 at the service provider system 102 may generate the digital video content 114 using the machine-learning models 118. For example, the service provider system 102 generates the text tokens and the transition tokens from the text prompt 120 and one or more video tokens that include noise. The service provider system 102 concatenates the text tokens, the video tokens, and the transition tokens to obtain a concatenated sequence of tokens. The service provider system 102 provides the concatenated sequence of tokens as input to the machine-learning models 118 and receives the digital video content 114 as output from the machine-learning models 118. The service provider system 102 may transmit the digital video content 114 to the computing device 104, and the computing device 104 may output the digital video content 114 via the user interface 124 at the display 126.

The computing device 104 may output a selectable option 128 via the user interface 124 at the display 126. The selectable option 128 may be selectable (e.g., via user input) to download the generated digital video content 114. Through interaction of a user with the computing device 104, the computing device 104 may receive user input (e.g., the text prompt 120, input at the selectable option 128) via the user interface 124. Examples of such input may include, but are not limited to, receiving touch input in relation to portions of the user interface 124, receiving one or more voice commands or other audio input, receiving typed input (e.g., via a physical or virtual (“soft”) keyboard), receiving mouse or stylus input, and so forth. In addition to, or as an alternative to the text prompt 120, the computing device 104 may receive image data as input via the user interface 124. The computing device 104 and/or the service provider system 102 may provide the image data as input to the machine-learning models 118 to generate the digital video content 114. Example image data may include, but is not limited to, photographs, scans, and individual digital video frames.

The computing device 104 may have various capabilities to generate the digital video content 114 using the machine-learning models 118. For example, the computing device 104 may be able to store and implement (e.g., deploy) the machine-learning models 118 locally depending on available memory resources, battery resources, and thermal management capabilities of the computing device 104. In some other examples, the computing device 104 may use cloud-based processing (e.g., at the service provider system 102) to offload computationally intensive tasks, providing for computing devices with reduced local computational resources or capabilities to leverage the machine-learning models 118.

Conventional diffusion-based text-to-video procedures produce relatively short digital videos (e.g., less than a threshold duration) of a single shot. The conventional procedures are not capable of generating multi-shot digital videos with discrete transitions, in which a same subject performs distinct activities across a same or different backgrounds. Conventional techniques for generating digital video include adapting text-to-image (T2I) models for digital video synthesis. Additionally, or alternatively, conventional techniques for generating digital video include implementing text-to-video (T2V) diffusion models, which demonstrate improved performance relative to T2I models by processing an entire digital video as a unified input rather than handling each frame independently. However, conventional models, including the T2I and T2V models, are configured to generate a single continuous digital video and are unable to generate a multi-shot digital video with each shot being separated by discrete cuts in dynamic elements. For example, a multi-shot digital video can include a same subject engaged in multiple different or distinct activities. The multi-shot digital video can include multiple different activities with unique settings, which conventional techniques for generating digital video may be unable to capture accurately. The different activities can have a same background, such as for a text prompt 120 “a man writes code and then sketches diagrams on a whiteboard.” Additionally, or alternatively, the different activities can have different backgrounds while maintaining a same identity, such as for a text prompt 120 “a man transitions from a home gym to a park bench.”

Conventional models generate digital videos of short durations (e.g., less than a threshold duration) and lack flexibility. In some examples, the conventional models are trained using single shot digital videos, which leads to reduced performance (e.g., reduced generation quality, increased use of computational resources) for multi-shot digital video synthesis featuring distinct actions or perspectives and featuring a same subject across diverse scenes and time frames. In some examples, to generate a multi-shot digital video, conventional techniques include generating a single shot digital video by combining shot-specific text prompts into a single text prompt. However, conventional models cannot create transitions between shots and also cannot provide different backgrounds for a same subject. Even within a same background, the conventional models cannot generate subjects featuring different activities with distinct settings, as the conventional models generate the relatively short videos. An extension of this approach is to generate each shot many times individually, then concatenate the most similar shots, which leads to the generation of numerous videos. For example, consistent keyframes of a character are generated using a reference image, animated with an I2V model, and concatenated to produce a multi-shot digital video. However, concatenating animated keyframes leads to inconsistencies and degraded quality and may not depict the subject within a same background performing distinct activities.

To provide for generating consistent and high-quality multi-shot digital video (e.g., greater than a threshold quality), the computing device 104 and/or the service provider system 102 can implement a framework that includes a dataset collection pipeline and architectural extensions to one or more video diffusion models (e.g., the machine-learning models 118) to enable text-to-multi-shot digital video generation. The service provider system 102 and/or the computing device 104 can generate a multi-shot digital video as a single digital video with full attention across the frames of the different shots, ensuring subject and background consistency and providing for users to control a number, duration, and content of shots through shot-specific conditioning. For example, the service provider system 102 and/or the computing device 104 incorporate one or more learnable tokens, referred to as transition tokens, into a text-to-video model to control at which frames a new shot begins. That is, the transition tokens signal the transition between shots, enabling multi-shot digital video generation, including a change in camera perspective between shots within a single background, a subject performing different activities between shots, or a background changing between shots, among other examples. A n identity of the subject may be preserved across the different shots in the multi-shot digital video. Additionally, or alternatively, the service provider system 102 and/or the computing device 104 implement local attention masking to control the impact of the transition token and to provide for shot-specific prompting.

In some cases, the service provider system 102 and/or the computing device 104 construct a multi-shot digital video dataset from a single shot digital video dataset through pre-processing and post-processing, which increases a size of a training dataset and leads to improved performance (e.g., based on identity and background consistency, text alignment, and shot-duration precision) of the machine-learning model 118. For example, the service provider system 102 and/or the computing device 104 obtain training data by constructing a multi-shot digital video dataset from existing single shot digital video datasets. The service provider system 102 and/or the computing device 104 fine-tune (e.g., update, train by performing five thousand iterations or less) one or more machine-learning models 118 using the training data to generate multi-shot digital videos with shot-specific control. The machine-learning models 118 include a pre-trained T2V model. The techniques described herein further overcome limitations of conventional techniques that are unable to generate multi-shot digital video or degrade a quality of multi-shot digital video and are computationally expensive or slow. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Machine Learning Model Implementation for Multi-Shot Digital Videos

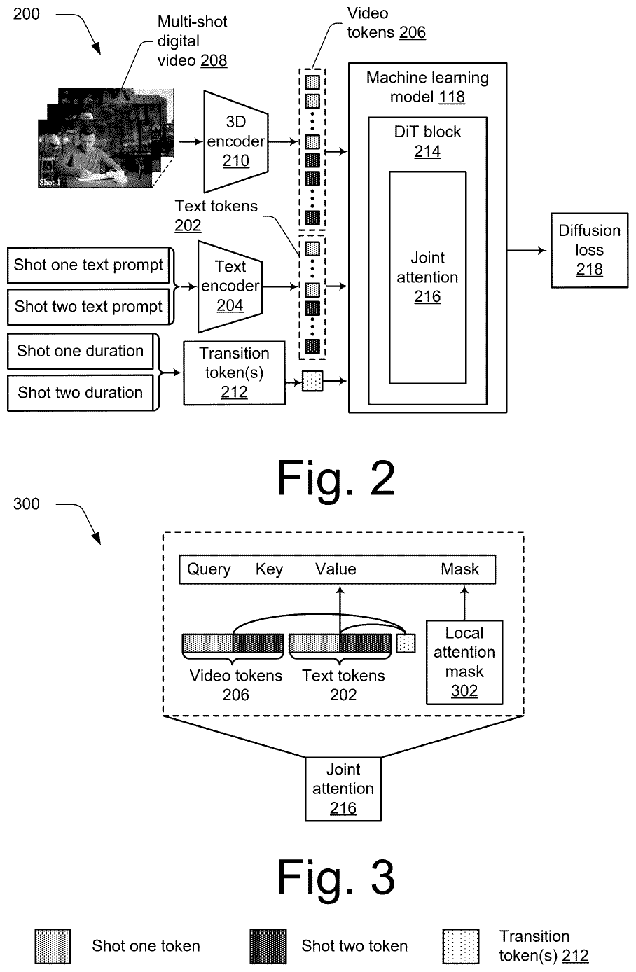

FIG. 2 depicts a system 200 as an example implementation of a machine-learning model that is operable by a device (e.g., a computing device or a device in a service provider system) to employ techniques described herein for generating a digital video with multiple shots. In some examples, the device implementing the system 200 may be an example of the computing device 104 and/or the service provider system 102 as described with reference to FIG. 1.

The system 200 includes an example of a device fine-tuning a machine-learning model 118, which may be an example of the machine-learning model 118 as described with reference to FIG. 1. The device can receive one or more text prompts describing different shots of a digital video, including a shot one text prompt for a first shot and a shot two text prompt for a second shot in a two-shot digital video. The device can generate one or more text tokens 202 from the text prompts using a text encoder 204. The text tokens 202 may include discrete string values, character values, or any other unit of text or representation of text. To convert a text prompt into the text tokens 202, the text encoder 204 parses the text prompt (e.g., the shot one text prompt and/or the shot two text prompt) into individual or discrete string values and/or characters using word segmentation techniques to split the text prompt based on punctuation and/or characters. The text encoder 204 may convert the parsed text prompt into numerical representations of the string values and/or characters, such as word embeddings. The text tokens 202 may be a compilation of the respective numerical representations of the text prompt.

The text encoder 204 may also identify contextual information, such as by using a large language model or other algorithm to identify semantic nuances in the text prompt. The text encoder 204 may generate the text tokens 202 by formatting a sequence of the text tokens 202 according to the contextual information for digital video generation. The text tokens 202 provide conditioning information to a machine-learning model 118 to guide the machine-learning model 118 to generate digital video content that aligns with the text prompt. The text tokens 202 can be divided into different shots, including text tokens 202 for a first shot (e.g., shot one tokens generated from the shot one text prompt) and text tokens 202 for a second shot (e.g., shot two tokens generated from the shot two text prompt) for a two-shot digital video.

The device generates one or more video tokens 206, also referred to as visual tokens or noise tokens, representative of a multi-shot digital video 208 using a 3D encoder 210. The video tokens 206 may include randomly generated noise when provided as input to a machine-learning model 118. The machine-learning model 118 can iteratively remove the noise from the video tokens 206. The video tokens 206 can be divided into different shots, including video tokens 206 for a first shot (e.g., shot one tokens) and video tokens 206 for a second shot (e.g., shot two tokens) for a two-shot digital video.

The device generates one or more transition tokens 212 from information related to a duration or a numerical quantity of shots, including a shot one duration and a shot two duration for a two-shot digital video. In some cases, the device determines (e.g., obtains, identifies) the information from one or more text prompts, such as the shot one text prompt and the shot two text prompt. The transition tokens 212 provide for the machine-learning model 118 to differentiate between different shots in the multi-shot digital video 208. The device fine-tunes a machine-learning model 118, which may be an example of a pre-trained machine-learning model (e.g., a DiT based model for T2V generation), by incorporating the transition tokens 212 in an input sequence of tokens. The device can use n-1 transition tokens 212 initialized as learnable parameters and an n-shot digital video (e.g., the multi-shot digital video 208) with shot-specific prompts. The device feeds (e.g., provides as input) the transition tokens 212 and the n-shot digital video through the machine-learning model 118.

For example, the device concatenates the text tokens 202, the video tokens 206, and the transition tokens 212 into a single sequence of tokens. The device provides the concatenated sequence of tokens (e.g., the text tokens 202, the video tokens 206, and the transition tokens 212) as input to the machine-learning model 118. The machine-learning model 118 includes a DiT block 214 that performs joint attention 216, which is described in further detail with respect to FIG. 3.

The machine-learning model 118 integrates the 3D encoder 210, which may be an example of a 3D variational autoencoder (3D-VA E), for video encoding. The machine-learning model 118 also integrates a variant of joint-attention layers for conditioning. For example, the device performs temporal and spatial encoding of input digital videos (e.g., the multi-shot digital video 208) via the 3D encoder 210 before being patchified to obtain patchified video tokens, including the video tokens 206. The device concatenates the text tokens 202 (e.g., textual condition tokens) with the patchified video tokens and processes the concatenated text tokens 202 and the video tokens 206 by a DiT block 214 in the machine-learning model 118. The machine-learning model 118 may be an example of a pre-trained T2V model that can generate a defined numerical quantity of frames with a resolution, such as 128 frames with 192×320 pixel resolution. The device fine-tunes the pre-trained T2V model to enable multi-shot generation. The device includes one or more transition tokens 212 in the input sequence of tokens and implements local attention masking. The device may additionally, or alternatively, support cross-attention based conditioning.

The transition token 212 is a learnable embedding that enables the machine-learning model 118 to learn transitions between consecutive shots within a multi-shot digital video 208. The device can initialize a set of learnable parameters at the start of fine-tuning, matching a hidden dimension of the input tokens. The hidden dimension of an input token refers to the size of the vector representation used to encode the information included in the token, where the hidden dimension defines an amount of information that can be captured and manipulated for each token. The device repeats the learnable parameters n−1 times, where n represents a defined number of shots, and appends the transition tokens 212 to the end of the input sequence of video tokens 206 and text tokens 202.

The device can implement a masking strategy in one or more attention layers of the machine-learning model 118. The masking strategy enables the transition tokens 212 to interact with the tokens corresponding to the frames where transitions are intended to occur. Thus, the machine-learning model 118 can learn to generate transitions between shots, while also providing for users to specify both a number of shots and respective durations of the shots, by replicating the transition tokens 212 and adjusting the attention mask, accordingly.

The device may fine-tune the machine-learning model 118 to minimize a diffusion loss 218. For example, to fine-tune the machine-learning model 118, the device can obtain a pre-trained machine-learning model and a training dataset including multi-shot digital video data. The device can implement an iterative fine-tuning procedure that minimizes the diffusion loss 218. The system 200 illustrates an example iteration using the multi-shot digital video 208, the text prompts for the different shots, and the shot durations as training data. The diffusion loss 218 may be a measure of how well the machine-learning model 118 can denoise and reconstruct data from various noise levels. The device can forward pass input data through the machine-learning model 118, adding noise at different timesteps, and then can predict and remove the added noise. During each training iteration, the device computes a difference between a denoised output and original input data. The diffusion loss 218 represents the difference. The device can use backpropagation to calculate gradients of the diffusion loss 218 with respect to parameters of the machine-learning model 118, including weights and biases of the machine-learning model 118. The device updates the parameters to reduce the diffusion loss 218. The device may continue to fine-tune the machine-learning model 118 until the diffusion loss 218 converges or satisfies a threshold value.

FIG. 3 depicts a system 300 as an example implementation of joint attention in a machine-learning model that is operable by a device (e.g., a computing device or a device in a service provider system) to employ techniques described herein for generating a digital video with multiple shots. In some examples, the device implementing the system 300 may be an example of the computing device 104 and/or the service provider system 102 as described with reference to FIG. 1.

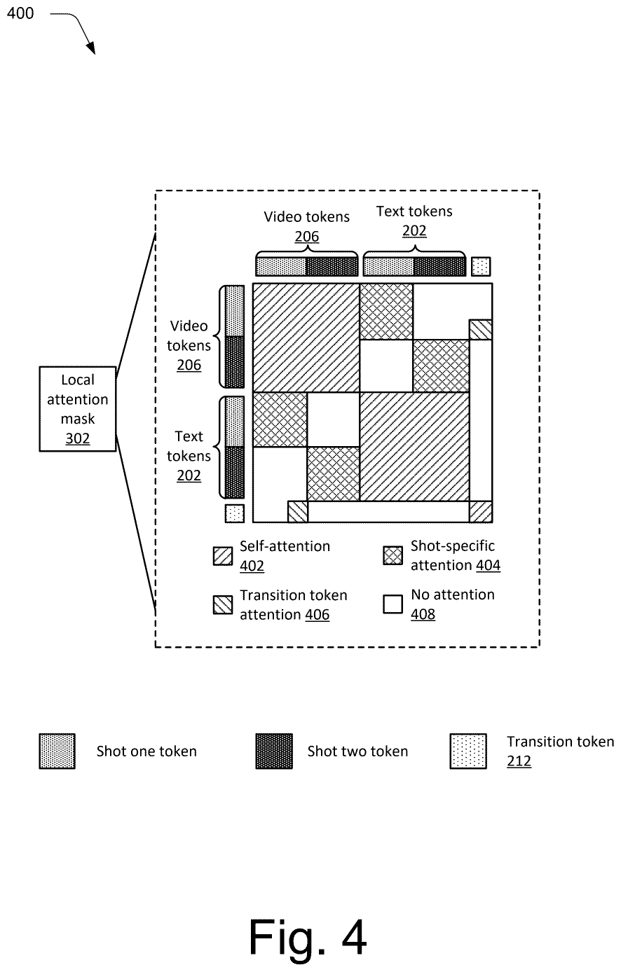

In some examples, a machine-learning model may perform joint attention 216 on a sequence of input tokens, which may include one or more video tokens 206, one or more text tokens 202, and one or more transition tokens 212, as described with reference to FIG. 2. For example, the machine-learning model processes the concatenated input token sequence, guided by a local attention mask 302, through joint attention layers within DiT blocks. Joint attention layers combine different types of attention mechanisms, such as self-attention for spatial and temporal relationships within video frames, cross-attention for conditioning on external inputs like text or audio, and temporal attention for capturing frame-to-frame dependencies. By computing and combining attention weights for each input source, joint attention layers provide for the machine-learning model to dynamically focus on relevant information (e.g., transitions between shots) when generating or processing digital video content. The local attention mask 302 is described in further detail with respect to FIG. 4.

A query in joint attention 216 represents information being used to generate an output, such as a text prompt for T2V generation. The device uses a key to calculate attention scores when matched against queries. The key represents the content to be attended to and is generated from spatial features of digital frames, temporal information from the digital frames, or external conditioning data, among other examples. The value includes the content that is aggregated based on the attention scores. The device computes attention weights using the queries and keys and applies the attention weights to the values to produce the output. The device can use one or more masks (e.g., the local attention masks 302) to control which attributes of the digital video generation to use in the attention computation.

FIG. 4 depicts a system 400 as an example implementation of a local attention mask in a machine-learning model that is operable by a device (e.g., a computing device or a device in a service provider system) to employ techniques described herein for generating a digital video with multiple shots. In some examples, the device implementing the system 400 may be an example of the computing device 104 and/or the service provider system 102 as described with reference to FIG. 1.

In some cases, a device can implement a local attention mask 302 when generating a multi-shot digital video to ensure that one or more transition tokens 212 interact with digital frames in which a transition between shots occurs, while each text token 202 interacts exclusively with a corresponding video token 206. The local attention mask 302, the transition tokens 212, the text tokens 202, and the video tokens 206 may be examples of the corresponding features as described with reference to FIGS. 2 and 3. For example, the text tokens 202 may be vector representations of one or more text prompts for different shots of a multi-shot digital video, including shot one tokens and shot two tokens for a two-shot digital video. The video tokens 206 may include noise values representative of the different shots of the multi-shot digital video, including shot one tokens and shot two tokens for a two-shot digital video. The local attention mask 302 focuses an attention computation to a defined portion or region of input data, where the attention computation provides for a machine-learning model to weight different portions of the input data.

For example, to enable shot-specific control, a device implements the local attention mask 302. Without implementing the local attention mask 302, all tokens in a sequence of input tokens interact with each other, diluting the impact of shot-specific information. The local attention mask 302 focuses attention interactions on defined token groups. The local attention mask 302 can indicate for the machine-learning model to implement self-attention 402 for a portion of the input data, shot-specific attention 404 for a portion of the input data, transition token attention 406 for a portion of the input data, or no attention 408 for a portion of the input data. For example, an attention matrix is masked to enforce one or more interactions, where the transition tokens 212 attend to the tokens at the transition frames (e.g., the transition token attention 406), while video tokens 206 and text tokens 202 are implement self-attention 402. Additionally, or alternatively, to enhance precise and localized control of text tokens 202 over corresponding video tokens 206, each text token 202 attends to associated video tokens 206 for shot-specific attention 404. A text token 202 for a first shot of a two-shot digital video (e.g., shot one token) attends to video tokens 206 for the first shot of the two-shot digital video. A text token 202 for a second shot of the two-shot digital video (e.g., shot two token) attends to video tokens 206 for the second shot of the two-shot digital video. Thus, the fine-tuned machine-learning model captures fine-grained dependencies between frames, shot specific text prompts, and shot transitions, leading to improved control over the multi-shot digital video generation.

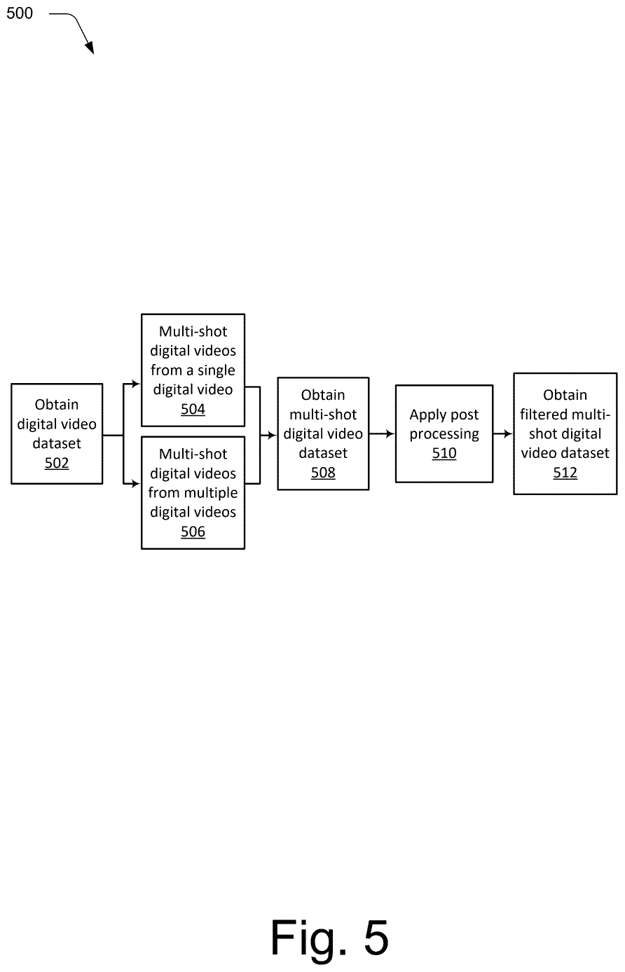

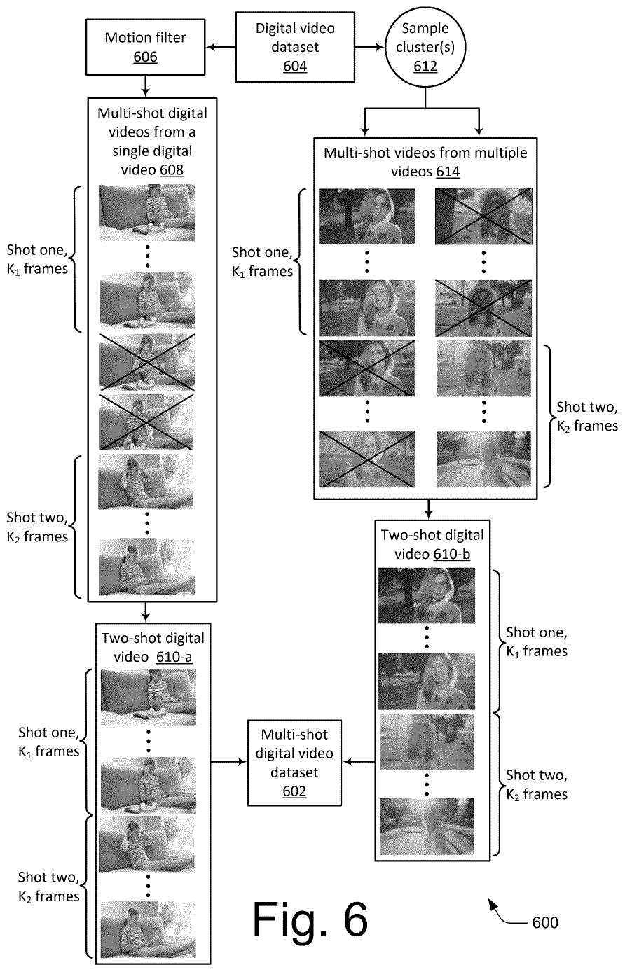

FIG. 5 depicts a procedure 500 for generating a dataset in an example implementation of digital video generation, which is performable by a computing device to generate a digital video with multiple shots. In some examples, the device implementing the procedure 500 may be an example of the computing device 104 and/or the service provider system 102 as described with reference to FIG. 1.

To perform fine-tuning of a machine-learning model, a device may generate (e.g., determine, identify, obtain) a dataset including multi-shot digital videos, where each shot in a multi-shot digital video depicts a same identity or subject both with a same and different backgrounds and features different activities. The device can implement two techniques to generate the multi-shot digital videos using a large-scale digital video dataset, which can include greater than a threshold numerical quantity of digital videos. A first technique includes the device generating multi-shot digital videos from single shot digital videos that are greater than a threshold duration and that exhibit greater than a threshold motion. A second technique includes the device combining multiple independent digital videos of a same subject to produce one or more multi-shot digital videos. The device applies post-processing to obtain shot specific captions and to ensure that the foreground identity or subject remains consistent across shots.

At 502, the device obtains a video dataset. The video dataset can include a set of digital videos that include single shot digital videos of a same subject. In some cases, at 504, the device obtains multi-shot digital videos from a single digital video, which is described in further detail with respect to FIG. 6. For example, to obtain multi-shot digital videos from single shot digital videos, the device randomly trims relatively short digital videos (e.g., less than a threshold numerical quantity of frames and/or duration) and combining the trimmed digital videos to create a new n-shot digital video. The device obtains optical flow maps using an algorithm, such as a recurrent all-pairs field transform (RAFT). The device computes an average motion in the x and y directions (tₓ, t_{y}) and a scaling ratio, s, for each digital video. The device discards digital videos with motion metrics below one or more defined thresholds, retaining digital videos with greater than a threshold amount of motion in at least one metric. Additionally, or alternatively, the device excludes or discards digital videos with fewer than a threshold numerical quantity of digital frames (e.g., 250 digital frames) to ensure sufficient variability. The device selects random portions of digital videos (e.g., sub-clips, sets of digital frames) of random duration and concatenates the portions of the digital video in a random order to generate a dataset of multi-shot digital videos.

In some other cases, at 506, the device obtains multi-shot digital videos from multiple digital videos, which is described in further detail with respect to FIG. 6. For example, to obtain multi-shot digital videos from multiple digital videos, the device performs clustering on a single-video dataset,

$$𝒟 = \{ {G}_{1}^{{M}_{1}} , … , {G}_{n}^{{M}_{n}} \} ,$$

where each cluster

$${G}_{j}^{{M}_{j}}$$

includes Mⱼ digital videos featuring a same foreground subject.

The device constructs the clusters by selecting digital videos uploaded by a same user within a same duration (e.g., 3 days), and digital videos that match based on the similarity of captions of the digital videos. The device can obtain a threshold numerical quantity of clusters (e.g., 550 thousand clusters), with an average of six digital videos per cluster. The device generates a fixed or defined numerical quantity of multi-shot digital videos for each cluster by randomly trimming clips from separate digital videos within a same cluster.

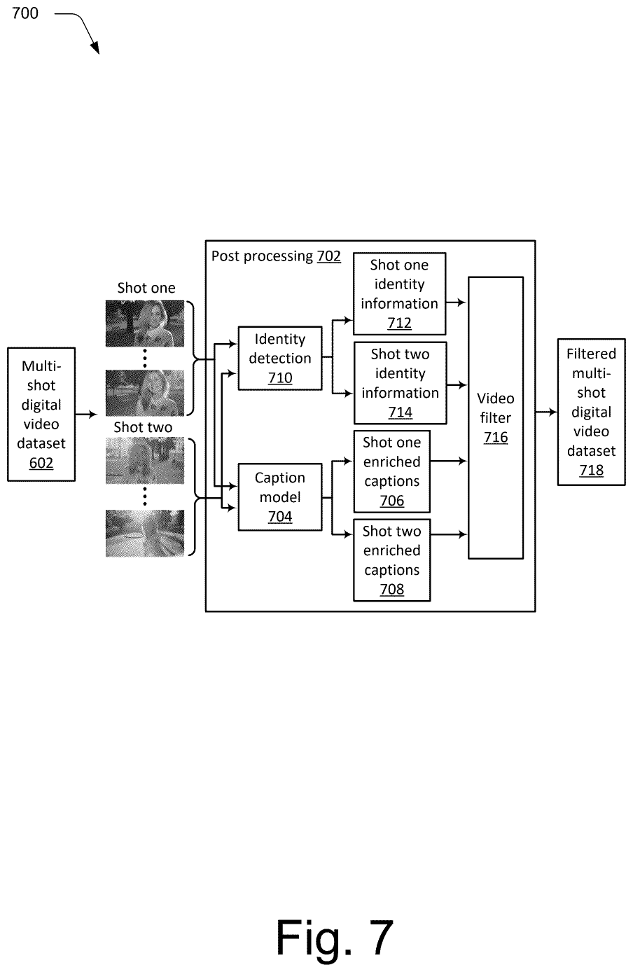

At 508, the device obtains a multi-shot digital video dataset, such as from the multi-shot digital videos from a single digital video and/or the multi-shot digital videos from the multiple digital videos. At 510, the device can apply post processing to the multi-shot digital video dataset, which is described in further detail with respect to FIG. 7. At 512, the device obtains a filtered multi-shot digital video dataset to use for fine-tuning a machine-learning model, as described with reference to FIGS. 1 through 4.

FIG. 6 depicts a procedure 600 for various techniques for collecting a dataset in an example implementation of digital video generation, which is performable by a computing device to generate a digital video with multiple shots. In some examples, the device implementing the procedure 600 may be an example of the computing device 104 and/or the service provider system 102 as described with reference to FIG. 1.

In some cases, a device can obtain a multi-shot digital video dataset 602 from a digital video dataset 604 including single shot digital videos. For example, a device can apply a motion filter 606 to the digital video dataset 604. The motion filter 606 provides for the device to select digital videos from the digital video dataset 604 that satisfy one or more motion metrics (e.g., greater than a threshold motion of a subject of the digital videos) and discard the remaining digital videos. The motion metrics can include, but are not limited to, an optical flow that indicates the motion of subjects between consecutive digital frames of a digital video, a motion vector magnitude that indicates an amount of movement for each pixel between digital frames, or a frame difference that indicates pixel-wise differences between consecutive digital frames, among other examples. The device applies the motion filter 606 to obtain multi-shot digital videos from a single digital video 608.

The multi-shot digital videos from a single digital video 608 can include multiple shots, such as a first shot (e.g., shot one) and a second shot (e.g., shot two) in a two-shot digital video 610-a. The first shot can include K₁ frames, which can include any numerical quantity of digital frames. The second shot can include K₂ frames, which can include any numerical quantity of digital frames. The device can sample digital videos with greater than a threshold amount of motion, randomly split the digital videos into n-shots with varied durations, and concatenate the shots into a multi-shot digital video from a single digital video 608. The device can include the generated multi-shot digital video from a single digital video 608 (e.g., the two-shot digital video 610-a) in a multi-shot digital video dataset 602.

In some examples, a device can generate one or more sample clusters 612 for generating multi-shot digital videos from multiple digital videos 614. The multi-shot digital videos from multiple digital videos 614 can include multiple shots, such as a first shot (e.g., shot one) and a second shot (e.g., shot two) in a two-shot digital video 610-b. The first shot can include K₁ frames, which can include any numerical quantity of digital frames. The second shot can include K₂ frames, which can include any numerical quantity of digital frames. The device can randomly sample n digital videos from pre-clustered groups including digital videos with a same subject or identity, such as a same human. The pre-clustered groups include the sample clusters 612. The device concatenates the randomly sampled digital videos to form a multi-shot digital video from multiple digital videos 614. The device can include the generated multi-shot digital video from multiple digital videos 614 (e.g., the two-shot digital video 610-b) in the multi-shot digital video dataset 602.

In some cases, the device can generate the multi-shot digital video from a single digital video 608 and the multi-shot digital video from multiple digital videos 614. Additionally, or alternatively, the device can generate one of the multi-shot digital video from a single digital video 608 or the multi-shot digital video from multiple digital videos 614, such as based on the contents of the digital video dataset 604. For example, if the digital video dataset 604 includes multiple digital videos with a same subject but does not include digital videos with greater than a threshold amount of motion, then the device can generate the multi-shot digital video dataset 602 by generating multi-shot digital videos from multiple digital videos 614. In some other examples, if the digital video dataset 604 does not include multiple digital videos with a same subject but does include digital videos with greater than a threshold amount of motion, then the device can generate the multi-shot digital video dataset 602 by generating the multi-shot digital video from a single digital video 608.

FIG. 7 depicts a procedure 700 for post processing of a dataset in an example implementation of digital video generation, which is performable by a computing device to generate a digital video with multiple shots. In some examples, the device implementing the procedure 700 may be an example of the computing device 104 and/or the service provider system 102 as described with reference to FIG. 1.

In some examples, the device can apply post processing 702 to a multi-shot digital video dataset 602, which may be an example of the multi-shot digital video dataset 602 as described with reference to FIG. 6. The multi-shot digital video dataset 602 can include multiple shots, such as a shot one and a shot two.

The device applies the post processing 702 to obtain shot-specific prompts and to ensure identity or subject consistency across shots. Each shot in the multi-shot digital video dataset 602 has a corresponding text description. The device can implement a machine-learning model (e.g., a large language and vision assistant (LLaVA) model, an LLaVA-NEXT model) to generate shot-specific captions. For example, the device can use a caption model 704 to generate one or more shot one enriched captions 706 and one or more shot two enriched captions 708.

The device can apply identity detection 710 to the multi-shot digital video dataset 602 to ensure identity or subject consistency across shots. The device removes or filters out digital videos from the multi-shot digital video dataset 602 that include more than one subject (e.g., character, object) or featuring different identities. The identity detection 710 can include a real-time object detection algorithm (e.g., you only look once (Y OLO) algorithm) as a person detector in the middle frames of each shot within a multi-shot digital video. To verify identity consistency, the device can use embeddings from a computer vision model (e.g., data-efficient image network (DINO) version 2 (DINOv2)) and a threshold to ensure the same identity appears across all shots of a multi-shot digital video. For example, the device can determine whether the shot one identity information 712 obtained by the identity detection 710 is within a threshold similarity to the shot two identify information 714.

The device can apply a video filter 716 to the shot one identity information 712, the shot two identity information 714, the shot one enriched captions 706, and the shot two enriched captions 708 to obtain a filtered multi-shot digital video dataset 718. For example, the video filter 716 filters the multi-shot digital video dataset 602, resulting in a dataset of multi-shot digital videos (e.g., with 2, 3, and 4 shots) of varying durations, where a single consistent identity or subject performs similar or different activities across diverse backgrounds and motions.

### Example Visualization of Generated Digital Video Content

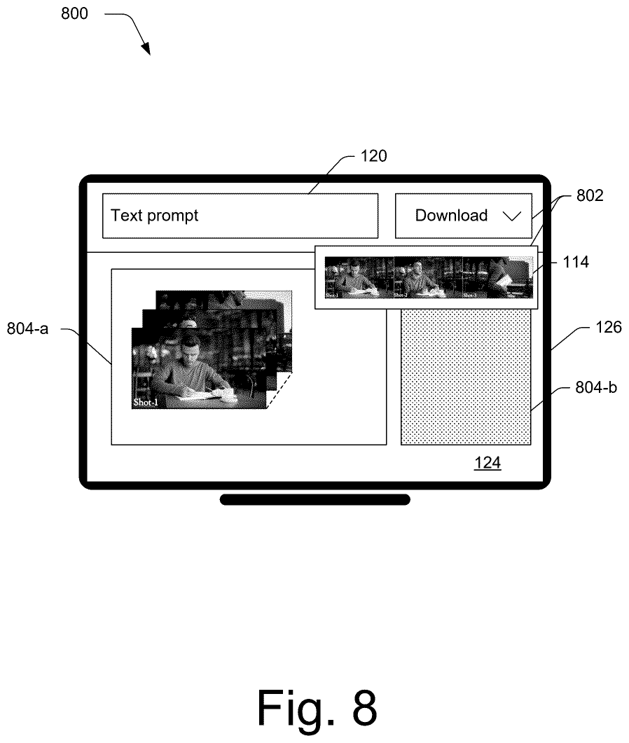

FIG. 8 depicts a visualization 800 of displaying digital video content that is generated based on a text prompt. In some examples, a computing device includes a user interface 124 at a display 126 of the computing device that outputs the visualization 800 including digital video content 114 in response to a text prompt 120, where the computing device, the user interface 124, the display 126, the digital video content 114, and the text prompt 120, are examples of the corresponding features as described with reference to FIG. 1.

In some examples, a computing device receives one or more text prompts 120 that are representative of one or more shots of a multi-shot digital video. The text prompt 120 can include, but is not limited to, one or more descriptors of attributes (e.g., features, characteristics, elements) of a subject of the multi-shot digital video, one or more criterion for the subject of the multi-shot digital video (e.g., a ratio of the subject to a size of the digital video), one or more criterion related to generation of the multi-shot digital video (e.g., a size, a resolution), a numerical quantity of shots in the multi-shot digital video, or a duration of each shot of the multi-shot digital video, among other information. The computing device uses the text prompt to generate a sequence of tokens to use to generate the digital video content 114, as described with reference to FIGS. 1 through 4. The computing device may output the digital video content 114 at the user interface 124.

The computing device can output a selectable control 802. The selectable control 802 may be an example of a button, a drop down menu, a text field, or any other element of a user interface 124 configured to receive input. The selectable control 802 facilitates display of the digital video content 114 at a selected portion of the user interface 124. The computing device can receive a selection via the selectable control 802. For example, the computing device receives input that indicates a location on the user interface 124 at which the computing device is to display the digital video content 114. The user may make a drag and drop motion to indicate the location, may select the location from a list of available windows, including the window 804-a and the window 804-b, or may specify the location, among other examples. The computing device propagates the digital video content 114 to the indicated (e.g., selected) location on the user interface 124. The digital video content 114 includes a multi-shot digital video, which can include a same identity or subject across the different shots of the multi-shot digital video.

### Example Procedures for Generating Digital Video Content

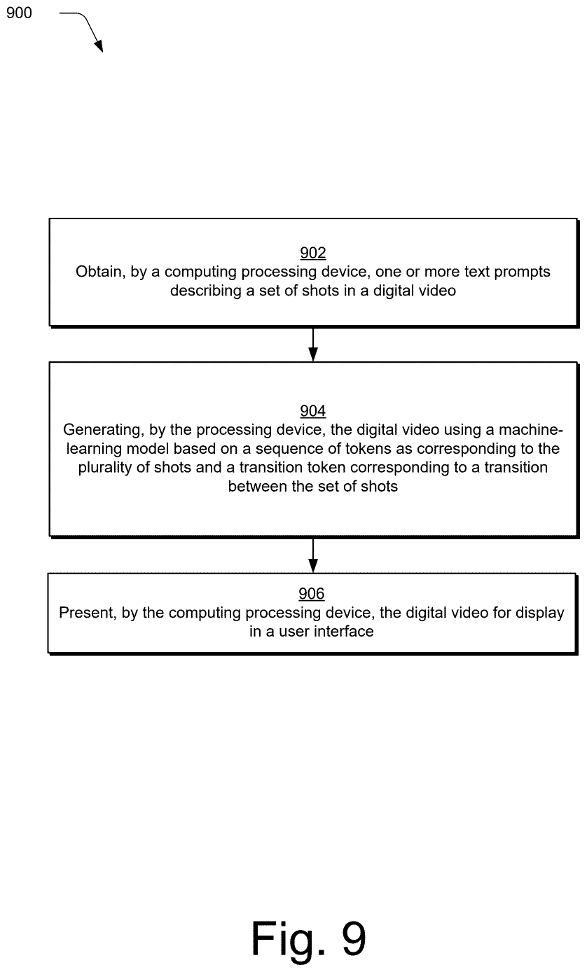

FIG. 9 is a flow diagram depicting an algorithm as a step-by-step procedure 900 in an example implementation of digital video generation, which is performable by a computing device, which may also be referred to as a processing device, to generate a digital video with multiple shots. In some examples, the step-by-step procedure 900 can be executed by a computing device, such as a computing device 104, as described with reference to FIG. 1.

One or more text prompts corresponding to respective shots of a digital video are obtained by a computing device (block 902). The digital video includes multiple shots and can be referred to as a multi-shot digital video. In some cases, the respective shots include a set of frames of the digital video with one or more attributes that satisfy a first threshold rate of change of motion within the set of frames. For example, the attributes of the frames in a shot can exhibit less than a threshold rate of change of motion. The one or more attributes include one or more of a foreground subject of the set of frames or a respective shot, a background of the set of frames or a respective shot, an action of the foreground subject of the set of frames or a respective shot, or a capture perspective of the set of frames or a respective shot. The multiple shots are separated by a second threshold rate of change of motion within the set of frames. For example, the attributes of frames between different shots can exhibit greater than a threshold rate of change of motion. If the multi-shot digital video includes a shot of a woman knitting on the couch and a shot of the woman organizing clothes in a closet, then the motion of the woman knitting on the couch can be less than a threshold rate of change of motion, while the motion between the woman knitting on the couch and organizing the clothes can be greater than a threshold rate of change of motion.

The digital video is generated by the computing device using a machine-learning model based on a sequence of tokens (e.g., a concatenated sequence of text tokens and video tokens, including noise tokens) corresponding to the set shots of the digital video and a transition token corresponding to a transition between the set of shots (block 904). In some examples, the sequence of text tokens, the sequence of video tokens, and the sequence of transition tokens can include any numerical quantity of tokens. The sequence of video tokens can include a sequence of noise tokens. In some cases, the multiple shots are associated with a same foreground subject. The set of text prompts can indicate at least one of a duration of the respective shots or a numerical quantity of shots in the digital video.

In some cases, the computing device generates a sequence of one or more transition tokens, including the transition token. The transition tokens include one or more vector embeddings that indicate transitions between consecutive shots of the multiple shots. The text prompts can identify (e.g., define, indicate) the transitions between the consecutive shots, including a numerical quantity of shots in the digital video and/or a duration of the shots. The computing device applies an attention mask to groups of tokens of the sequence of tokens using the transition tokens. The groups of tokens can be defined for the respective shots. In some cases, generating the multiple shots of the digital video includes removing noise from the sequence of noise tokens.

The digital video is presented for display at a user interface of the computing device (block 906). In some cases, the computing device generates training data, which can include a dataset of multi-shot digital videos. The computing device can parse a first set of digital videos including respective single shots to obtain a second set of digital videos including respective multiple shots. Additionally, or alternatively, the computing device can combine a third set of digital videos that has a same foreground subject, where respective digital videos of the third set of digital videos include a single shot. The computing device can obtain an additional set of one or more text prompts (e.g., captions) from one or more of the second set of digital videos or the third set of digital videos, as described with reference to FIG. 7. The training data includes one or more of the second set of digital videos, the third set of digital videos, or the additional set of text prompts. The computing device can fine-tune (e.g., update, train) one or more parameters of a machine-learning model using the training data. The fine-tuning can cause the machine-learning model to generate the digital video from the set of text prompts.

In some cases, the computing device generates the multiple shots of the digital video by providing the sequence of tokens as input to the machine-learning model. The computing device obtains the multiple shots of the digital video as output from the machine-learning model. In some examples, the computing device receives an indication of parameters representative of the machine-learning model from a service provider system. For example, the service provider system trains and/or fine-tunes the machine-learning model and sends one or more parameters of the machine-learning model to the computing device. In some cases, the machine-learning model is a DiT model.

In some cases, the computing device transmits the text prompts and/or the sequence of tokens to a service provider system. For example, if the computing device is not capable of implementing the machine-learning model to generate the multiple shots of the digital video due to a processing capability of the computing device, a memory capability of the computing device, a power capability of the computing device, a temperature regulation capability of the computing device, or any other capability of the computing device, then the computing device transmits the text prompts and/or the sequence of tokens to the service provider system. The computing device receives the multiple shots of the digital video from the service provider system. The computing device outputs the digital video responsive to receiving the digital video.

In some examples, outputting the digital video includes displaying the digital video at a user interface of the computing device. For example, the computing device can output a selectable control at the user interface of the computing device to facilitate display of the digital video at a selected portion of the user interface. The computing device can display the digital video at the selected portion of the user interface responsive to input at the selectable control.

In some examples, the computing device obtains multiple portions from one or more source digital videos. The computing device generates a set of training digital videos using the portions from the source digital videos. In some cases, respective training digital videos of the set of training digital videos are generated to include multiple shots. The computing device trains a machine-learning model based on the set of training digital videos. In some examples, at least one training digital video of the set of training digital videos is generated from a single source digital video filtered from the one or more source digital videos having a single shot according to an amount of motion exhibited by the single source digital video. Additionally, or alternatively, at least one training digital video of the set of training digital videos is generated by selecting the portions from a set of source digital videos.

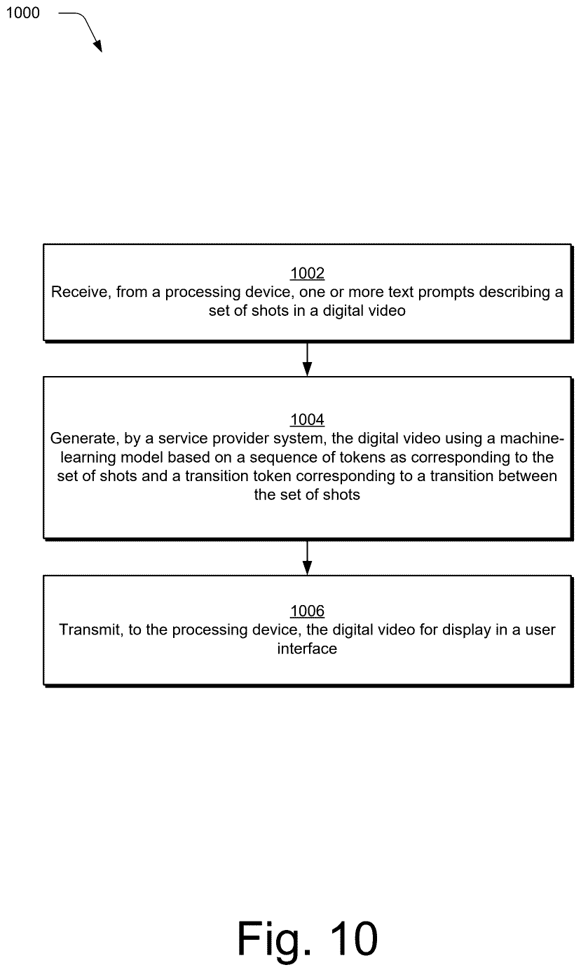

FIG. 10 is a flow diagram depicting an algorithm as a step-by-step procedure 1000 in an example implementation of digital video generation, which is performable by a service provider system to generate a digital video with multiple shots. In some examples, the step-by-step procedure 1000 can be executed by a service provider system and/or a device in the service provider system, such as a service provider system 102, as described with reference to FIG. 1.

One or more text prompts describing a set of shots in a digital video is received from a computing device, which may be an example of a processing device (block 1002). The digital video includes multiple shots (e.g., a multi-shot digital video). In some cases, the respective shots include a set of frames of the digital video with one or more attributes that satisfy a first threshold rate of change of motion within the set of frames. For example, the attributes of the frames in a shot can exhibit less than a threshold rate of change of motion. The one or more attributes include one or more of a foreground subject of the set of frames or of a respective shot, a background of the set of frames or of a respective shot, an action of the foreground subject of the set of frames or of a respective shot, or a capture perspective of the set of frames or of a respective shot. The multiple shots are separated by a second threshold rate of change of motion within the set of frames. For example, the attributes of frames between different shots can exhibit greater than a threshold rate of change of motion. If the multi-shot digital video includes a shot of a woman knitting on the couch and a shot of the woman organizing clothes in a closet, then the motion of the woman knitting on the couch can be less than a threshold rate of change of motion, while the motion between the woman knitting on the couch and organizing the clothes can be greater than a threshold rate of change of motion.

The digital video is generated by the service provider system using a machine-learning model based on a sequence of tokens (e.g., a concatenated sequence of text tokens and video tokens, including noise tokens) corresponding to the set shots of the digital video and a transition token corresponding to a transition between the set of shots (block 1004). In some examples, the sequence of text tokens, the sequence of video tokens, and the sequence of transition tokens can include any numerical quantity of tokens. The sequence of video tokens can include a sequence of noise tokens. In some cases, the multiple shots are associated with a same foreground subject. The set of text prompts can indicate at least one of a duration of the respective shots or a numerical quantity of shots in the digital video.

In some cases, the service provider system generates a sequence of one or more transition tokens, including the transition token. The transition tokens include one or more vector embeddings that indicate transitions between consecutive shots of the multiple shots. The text prompts can identify (e.g., define, indicate) the transitions between the consecutive shots, including a numerical quantity of shots in the digital video and/or a duration of the shots. The computing device applies an attention mask to groups of tokens of the sequence of tokens using the transition tokens. The groups of tokens can be defined for the respective shots. In some cases, generating the multiple shots of the digital video includes removing noise from the sequence of noise tokens.

The digital video is transmitted to the computing device for display in a user interface (block 1006). For example, the service provider system transmits the digital video to the computing device for display at a user interface of the computing device, as described with reference to FIGS. 8 and 9.

In some cases, the service provider system generates training data, which can include a dataset of multi-shot digital videos. The service provider system can parse a first set of digital videos including respective single shots to obtain a second set of digital videos including respective multiple shots. Additionally, or alternatively, the service provider system can combine a third set of digital videos that has a same foreground subject, where respective digital videos of the third set of digital videos include a single shot. The service provider system can obtain an additional set of one or more text prompts (e.g., captions) from one or more of the second set of digital videos or the third set of digital videos, as described with reference to FIG. 7. The training data includes one or more of the second set of digital videos, the third set of digital videos, or the additional set of text prompts. The service provider system can fine-tune (e.g., update, train) one or more parameters of a machine-learning model using the training data. The fine-tuning can cause the machine-learning model to generate the digital video from the set of text prompts.

In some cases, the service provider system generates the multiple shots of the digital video by providing the sequence of tokens as input to the machine-learning model. The service provider system obtains the multiple shots of the digital video as output from the machine-learning model. In some examples, the service provider system transmits an indication of parameters representative of the machine-learning model to a computing device. For example, the service provider system trains and/or fine-tunes the machine-learning model and sends one or more parameters of the machine-learning model to the computing device. In some cases, the machine-learning model is a DiT model.

In some cases, the service provider system receives the text prompts and/or the sequence of tokens from the computing device. For example, if the computing device is not capable of implementing the machine-learning model to generate the multiple shots of the digital video due to a processing capability of the computing device, a memory capability of the computing device, a power capability of the computing device, a temperature regulation capability of the computing device, or any other capability of the computing device, then the computing device transmits the text prompts and/or the sequence of tokens to the service provider system.

Example Architectures for Machine learning models

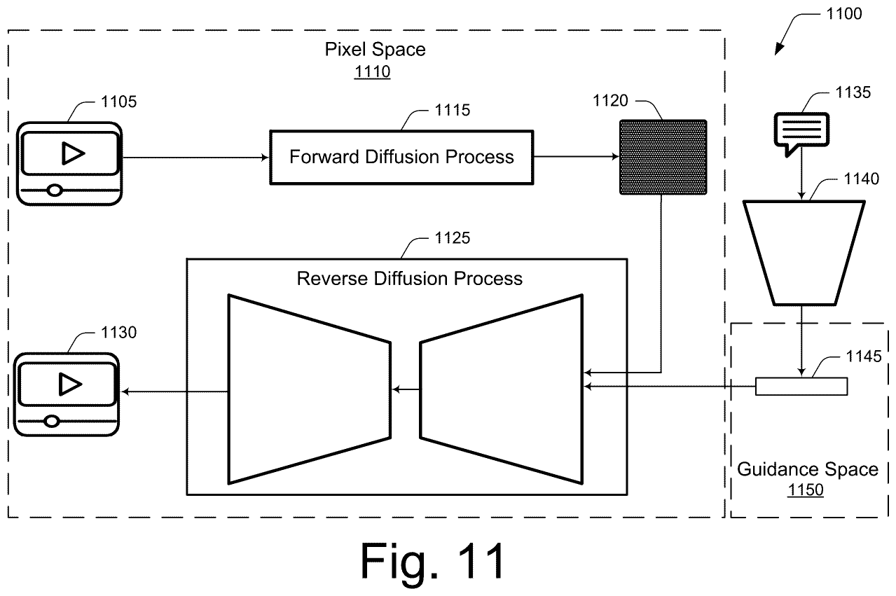

FIG. 11 shows an example of a guided diffusion model 1100 according to aspects of the present disclosure. In some examples, guided diffusion model 1100 describes the operation and architecture of the machine-learning model 118 described with reference to FIG. 1. The guided diffusion model 1100 depicted in FIG. 11 is an example of, or includes aspects of, a digital video generation model as described herein.

Diffusion models are a class of generative neural networks which can be trained to generate new data with features similar to features found in training data. In particular, diffusion models can be used to generate novel media items such as images, audio files, videos, 3D models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided diffusion model 1100 may take an original media item 1105 in a pixel space 1110 as input and apply forward diffusion process 1115 to gradually add noise to the original media item 1105 to obtain noisy media item 1120 at various noise levels.

Next, a reverse diffusion process 1125 (e.g., a U-Net) gradually removes the noise from the noisy media item 1120 at the various noise levels to obtain an output media item 1130. In some cases, an output media item 1130 is created from each of the various noise levels. The output media item 1130 can be compared to the original media item 1105 to train the reverse diffusion process 1125.

The reverse diffusion process 1125 can also be guided based on a text prompt 1135 (e.g., the text prompt 120, as described with reference to FIGS. 1 and 8), or another guidance prompt, such as an image, a layout, a segmentation map, etc. The text prompt 1135 can be encoded using a text encoder 1140 (e.g., a multimodal encoder) to obtain guidance features 1145 in guidance space 1150. The guidance features 1145 can be combined with the noisy media item 1120 at one or more layers of the reverse diffusion process 1125 to ensure that the output media item 1130 includes content described by the text prompt 1135. For example, guidance features 1145 can be combined with the noisy features using a cross-attention block within the reverse diffusion process 1125.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

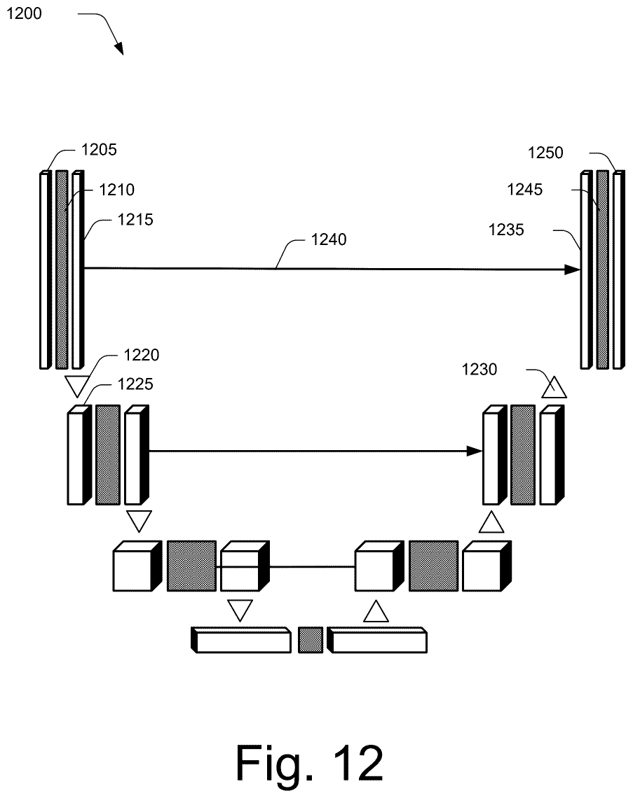

FIG. 12 shows an example of a U-Net 1200 according to aspects of the present disclosure. In some examples, U-Net 1200 is an example of the component that performs the reverse diffusion process 1125 of guided diffusion model 1100 described with reference to FIG. 11 and includes architectural elements of the machine-learning model 118 described with reference to FIG. 1. The U-Net 1200 depicted in FIG. 12 is an example of, or includes aspects of, the architecture used within the reverse diffusion process described with reference to FIG. 11.

In some examples, diffusion models are based on a neural network architecture known as a U-Net. The U-Net 1200 takes input features 1205 having an initial resolution and an initial number of channels and processes the input features 1205 using an initial neural network layer 1210 (e.g., a convolutional network layer) to produce intermediate features 1215. The intermediate features 1215 are then down-sampled using a down-sampling layer 1220 such that down-sampled features 1225 features have a resolution less than the initial resolution and a number of channels greater than the initial number of channels.

This process is repeated multiple times, and then the process is reversed. That is, the down-sampled features 1225 are up-sampled using up-sampling process 1230 to obtain up-sampled features 1235. The up-sampled features 1235 can be combined with intermediate features 1215 having the same resolution and number of channels via a skip connection 1240. These inputs are processed using a final neural network layer 1245 to produce output features 1250. In some cases, the output features 1250 have the same resolution as the initial resolution and the same number of channels as the initial number of channels.

In some cases, U-Net 1200 takes additional input features to produce conditionally generated output. For example, the additional input features could include a vector representation of an input prompt. The additional input features can be combined with the intermediate features 1215 within the neural network at one or more layers. For example, a cross-attention module can be used to combine the additional input features and the intermediate features 1215.

Example Inference Using Machine learning models

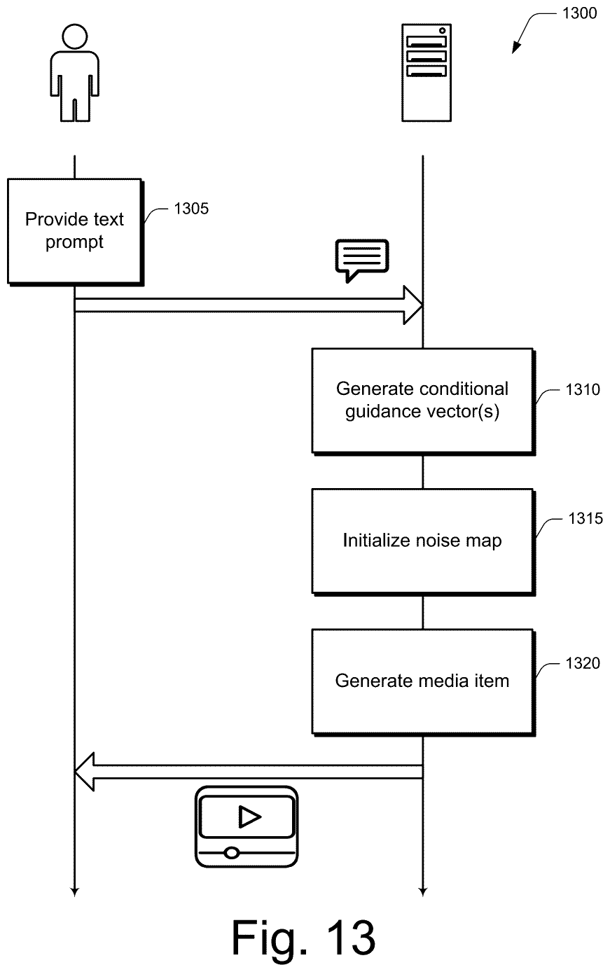

FIG. 13 shows an example of a method 1300 for conditional media generation according to aspects of the present disclosure. In some examples, method 1300 describes an operation of the machine-learning model 118 described with reference to FIG. 1 such as an application of the guided diffusion model 1100 described with reference to FIG. 11. In some examples, these operations are performed by a system including a processor executing a set of codes to control functional elements of an apparatus such as the media generation model described in FIG. 11.

Additionally, or alternatively, steps of the method 1300 may be performed using special-purpose hardware. Generally, these operations are performed according to the methods and processes described in accordance with aspects of the present disclosure. In some cases, the operations described herein are composed of various sub-steps or are performed in conjunction with other operations.

At operation 1305, a user provides a text prompt describing content to be included in a generated media item. For example, a user may provide the prompt “a person playing with a cat.” In some examples, guidance can be provided in a form other than text, such as via an image, a sketch, or a layout.

At operation 1310, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1315, a noise map is initialized that includes random noise. The noise map may be in a pixel space or a latent space. By initializing a media item with random noise, different variations of a media item including the content described by the conditional guidance can be generated.

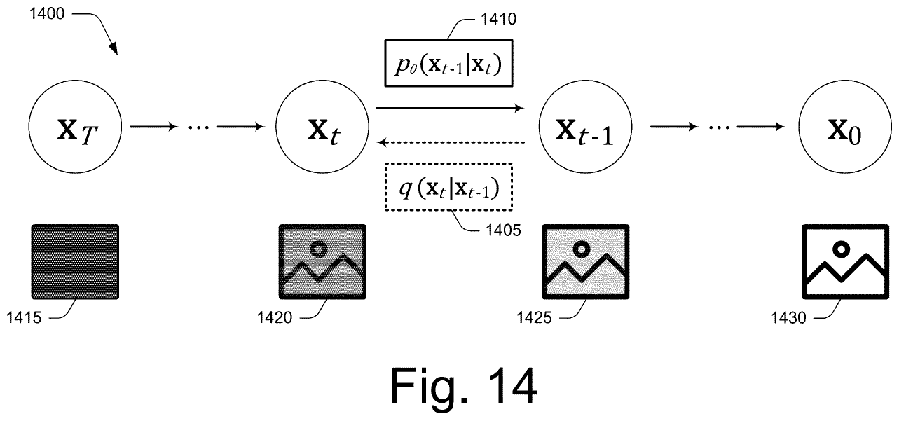

At operation 1320, the system generates a media item based on the noise map and the conditional guidance vector. For example, the media item may be generated using a reverse diffusion process as described with reference to FIG. 14.

FIG. 14 shows a diffusion process 1400 according to aspects of the present disclosure. In some examples, diffusion process 1400 describes an operation of the machine-learning model 118 described with reference to FIG. 1, such as the reverse diffusion process 1125 of guided diffusion model 1100 described with reference to FIG. 11.

As described above with reference to FIG. 11, using a diffusion model can involve both a forward diffusion process 1405 for adding noise to a media item (or features in a latent space) and a reverse diffusion process 1410 for denoising the media item (or features) to obtain a denoised media item. The forward diffusion process 1405 can be represented as q(xₜ|xₜ₋₁), and the reverse diffusion process 1410 can be represented as p(xₜ₋₁|xₜ). In some cases, the forward diffusion process 1405 is used during training to generate media items with successively greater noise, and a neural network is trained to perform the reverse diffusion process 1410 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1410, the model begins with noisy data x_{T}, such as a noisy media item 1415 and denoises the data to obtain the p(xₜ₋₁|xₜ). At each step t−1, the reverse diffusion process 1410 takes xₜ, such as first intermediate media item 1420, and t as input. Here, t represents a step in the sequence of transitions associated with different noise levels, The reverse diffusion process 1410 outputs xₜ₋₁, such as second intermediate media item 1425 iteratively until x_{T} reverts back to x₀, the original media item 1430. The reverse process can be represented as:

p_{θ}(xₜ₋₁|xₜ): =N(xₜ₋₁;μ_{θ}(xₜ,t),Σ_{θ}(xₜ,t)). (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, 1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data ã is mapped back into the pixel space from the latent space as output. In some examples, x₀ represents an original input media item with low quality, latent variables x₁, . . . , x_{T} represent noisy media items, and \tilde{x} represents the generated item with high quality.

Example Machine learning model Training Procedures

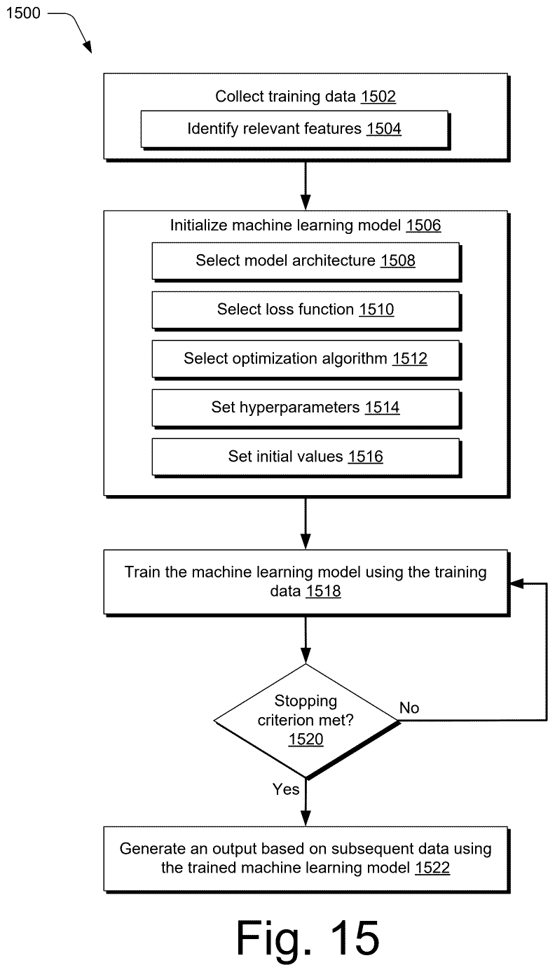

FIG. 15 is a flow diagram depicting an algorithm as a step-by-step procedure 1500 in an example implementation of operations performable for training a machine-learning model. In some cases, the procedure 1500 describes an operation of a component that trains the machine-learning model 118 described with reference to FIG. 1. The procedure 1500 provides one or more examples of generating training data, use of the training data to train a machine-learning model, and use of the trained machine-learning model to perform a task.

To begin in this example, a machine-learning system collects training data (block 1502) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1506). Initialization of the machine-learning model includes selecting a model architecture (block 1508) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1510). The loss function is utilized to measure a difference between an output of the machine-learning model (i.e., predictions) and target values (e.g., as expressed by the training data) to be used to train the machine-learning model. Additionally, an optimization algorithm is selected (1512) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1516) examples of which include initializing weights and biases of nodes to improve efficiency in training and computational resources consumption as part of training. Hyperparameters are also set (block 1514) that are used to control training of the machine-learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including nodes that collectively form a set of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1520), the procedure 1500 continues training of the machine-learning model using the training data (block 1518) in this example.

If the stopping criterion is met (“yes” from decision block 1520), the trained machine-learning model is then utilized to generate an output based on subsequent data (block 1522). The trained machine-learning model, for instance, is trained to perform a task as described above and therefore once trained is configured to perform that task based on subsequent data received as an input and processed by the machine-learning model.

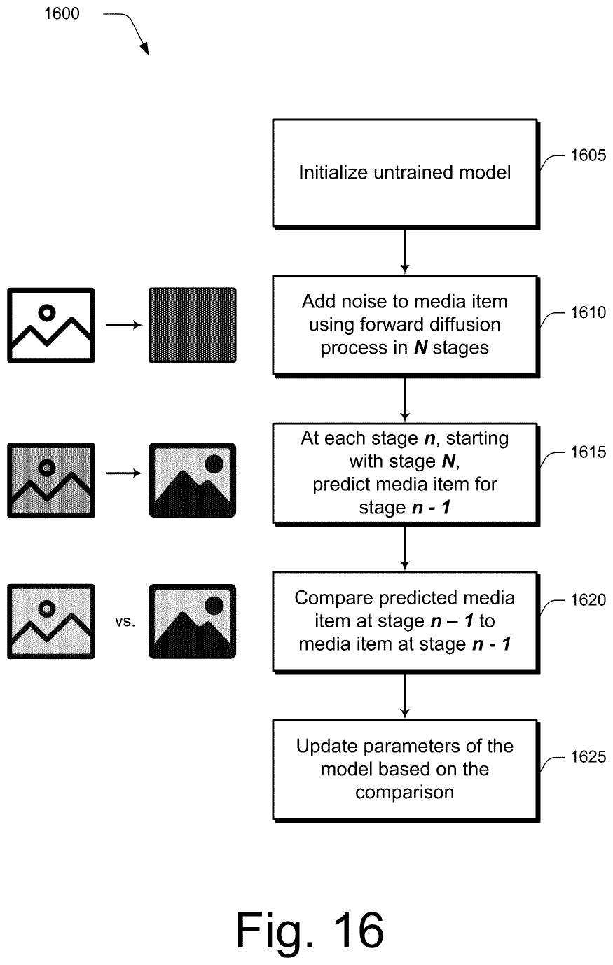

FIG. 16 shows an example of a method 1600 for training a diffusion model according to aspects of the present disclosure. In some cases, the method 1600 describes an operation of a component for training a machine-learning model 118 as described with reference to FIG. 1. The method 1600 represents an example for training a reverse diffusion process as described above with reference to FIG. 14. In some examples, these operations are performed by a system including a processor executing a set of codes to control functional elements of an apparatus, such as the guided diffusion model described in FIG. 1.

Additionally, or alternatively, certain processes of method 1600 may be performed using special-purpose hardware. Generally, these operations are performed according to the methods and processes described in accordance with aspects of the present disclosure. In some cases, the operations described herein are composed of various sub-steps or are performed in conjunction with other operations.

At operation 1605, the user initializes an untrained model. Initialization can include defining the architecture of the model and establishing initial values for the model parameters. In some cases, the initialization can include defining hyperparameters such as the number of layers, the resolution and channels of each layer blocks, the location of skip connections, and the like.

At operation 1610, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1615, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1620, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1625, the system updates parameters of the model based on the comparison. For example, parameters of a U-Net may be updated using gradient descent. Time-dependent parameters of the Gaussian transitions can also be learned.

### Example Systems and Devices

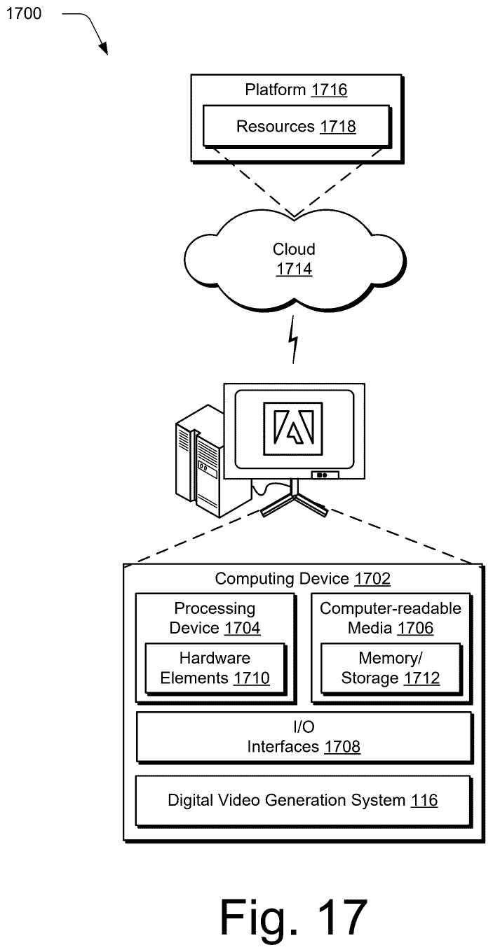

FIG. 17 illustrates an example system 1700 that includes an example computing device 1702 that is representative of one or more computing systems and/or devices that are usable to implement the various techniques described herein. This is illustrated through the inclusion of the digital video generation system 116. The computing device 1702 is configurable, for example, as a server of a service provider, a device associated with a client (e.g., a client device), an on-chip system, and/or any other suitable computing device or computing system.

The example computing device 1702, as illustrated, includes a processing device 1704, one or more computer-readable media 1706, and one or more I/O interfaces 1708 that are communicatively coupled, one to another. Although not shown, the computing device 1702 further includes a system bus or other data and command transfer system that couples the various components from one to another. For example, a system bus includes any combination of different bus structures, such as a memory bus or memory controller, a peripheral bus, a universal serial bus, and/or a processor or local bus that utilizes various bus architectures. A variety of other examples are also contemplated, such as control and data lines.

The processing device 1704 is representative of the functionality to perform one or more operations using hardware. Accordingly, the processing device 1704 is illustrated as including hardware elements 1710 that are configured as processors, functional blocks, and so forth. This includes example implementations in hardware as an application specific integrated circuit or other logic device formed using one or more semiconductors. The hardware elements 1710 are not limited by the materials from which they are formed or the processing mechanisms employed therein. For example, processors include semiconductor(s) and/or transistors (e.g., electronic integrated circuits (ICs)). In such a context, processor-executable instructions are, for example, electronically executable instructions.

The computer-readable media 1706 is illustrated as including memory/storage 1712. Memory/storage 1712 represents memory or storage capacity associated with one or more computer-readable media. In one example, the memory/storage 1712 includes volatile media (such as random access memory (RAM)) and/or nonvolatile media (such as read-only memory (ROM), Flash memory, optical disks, magnetic disks, and so forth). In another example, the memory/storage 1712 includes fixed media (e.g., RAM, ROM, a fixed hard drive, and so on) as well as removable media (e.g., Flash memory, a removable hard drive, an optical disc, and so forth). The computer-readable media 1706 is configurable in a variety of other ways, as further described below.

Input/output interface(s) 1708 are representative of functionality to allow a user to enter commands and information to computing device 1702 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1702 is configurable in a variety of ways, as further described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are stored on or transmitted across some form of computer-readable media. For example, the computer-readable media includes a variety of media accessible to the computing device 1702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 1702, such as via a network. Signal media typically embodies computer-readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1710 and computer-readable media 1706 are representative of modules, programmable device logic, and/or fixed device logic implemented in a hardware form that is employable in some cases to implement at least some aspects of the techniques described herein, such as to perform one or more instructions. Hardware includes components of an integrated circuit or on-chip system, an application-specific integrated circuit (A SIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 1710. For example, the computing device 1702 is configured to implement particular instructions and/or functions corresponding to the software and/or hardware modules. Accordingly, implementation of a module that is executable by the computing device 1702 as software is achieved at least partially in hardware, e.g., through the use of computer-readable storage media and/or hardware elements 1710 of the processing device 1704. The instructions and/or functions are executable/operable by one or more articles of manufacture (for example, one or more computing devices 1702 and/or processing devices 1704) to implement techniques, modules, and examples described herein.

The techniques described herein are supportable by various configurations of the computing device 1702 and are not limited to the specific examples of the techniques described herein. This functionality is also implementable entirely or partially through the use of a distributed system, such as over a “cloud” 1714, as described below.

The cloud 1714 includes and/or is representative of a platform 1716 for resources 1718. The platform 1716 abstracts the underlying functionality of hardware (e.g., servers) and software resources of the cloud 1714. For example, the resources 1718 include applications and/or data that are utilized while computer processing is executed on servers remote from the computing device 1702. In some implementations, the resources 1718 also include services provided over the Internet and/or through a subscriber network, such as a cellular or Wi-Fi network.

The platform 1716 abstracts the resources 1718 and functions to connect the computing device 1702 with other computing devices. In some implementations, the platform 1716 also serves to abstract scaling of resources to provide a corresponding level of scale to encountered demand for the resources implemented via the platform. Accordingly, in an interconnected device, the implementation of functionality described herein is distributable throughout the system 1700. For example, the functionality is implementable in part on the computing device 1702 as well as via the platform 1716 that abstracts the functionality of the cloud 1714.

In general, functionality, features, and concepts described in relation to the examples above and below are employed in the context of the example procedures described in this section. Further, functionality, features, and concepts described in relation to different FIGs. and examples in this document are interchangeable among one another and are not limited to implementation in the context of a particular FIG. or procedure. Moreover, blocks associated with different representative procedures and corresponding FIGs. herein are applicable together and/or combinable in different ways. Thus, individual functionality, features, and concepts described in relation to different example environments, devices, components, FIGs., and procedures herein are usable in any suitable combinations and are not limited to the particular combinations represented by the enumerated examples in this description.

What is claimed is:

1. A method comprising:
obtaining, by a processing device, one or more text prompts describing a plurality of shots in a digital video;
generating, by the processing device, the digital video using a machine-learning model based on a sequence of tokens as corresponding to the plurality of shots and a transition token corresponding to a transition between the plurality of shots; and
presenting, by the processing device, the digital video for display in a user interface.

2. The method of claim 1, wherein:
respective shots of the plurality of shots include one or more attributes that satisfy a first threshold rate of change of motion within the respective shots;
the one or more attributes include one or more of a foreground subject of the respective shots, a background of the respective shots, an action of the foreground subject of the respective shots, or a capture perspective of the respective shots; and
the respective shots are separated based on the one or more attributes satisfying a second threshold rate of change of motion across the respective shots.

3. The method of claim 1, wherein the generating the digital video includes:
generating the transition token based on one or more vector embeddings that indicate the transition between the plurality of shots, wherein the transition between the plurality of shots is based on the one or more text prompts; and
applying, based on the transition token, an attention mask to groups of tokens of the sequence of tokens, wherein the groups of tokens correspond to respective shots of the plurality of shots.

4. The method of claim 1, further comprising:
generating training data based on one or more of parsing a first set of digital videos including respective single shots to obtain a second set of digital videos including respective shots or combining a third set of digital videos associated with a same foreground subject, wherein respective digital videos of the third set of digital videos include a single shot;
obtaining, from one or more of the second set of digital videos or the third set of digital videos, one or more additional text prompts, wherein the training data includes one or more of the second set of digital videos, the third set of digital videos, or the one or more additional text prompts; and
updating, based on the training data, one or more parameters of the machine-learning model to cause the machine-learning model to generate the digital video from the one or more text prompts.

5. The method of claim 1, wherein the generating the digital video includes:
providing the sequence of tokens as input to the machine-learning model; and
obtaining, as output from the machine-learning model, the plurality of shots of the digital video.

6. The method of claim 1, further including receiving, from a service provider system, an indication of parameters representative of the machine-learning model, wherein the machine-learning model is a diffusion transformer model.

7. The method of claim 1, further comprising:
transmitting, to a service provider system and based on a capability of the processing device to implement the machine-learning model to generate the digital video, at least one of the one or more text prompts or the sequence of tokens; and
receiving, from the service provider system, the digital video, wherein presenting the digital video is responsive to receiving the digital video.

8. The method of claim 1, further comprising:
presenting, by the processing device, a selectable control for display in the user interface to facilitate display of the digital video at a selected portion of the user interface; and
presenting, responsive to input at the selectable control, the digital video at the selected portion of the user interface.

9. The method of claim 1, wherein the sequence of tokens includes a sequence of noise tokens, and wherein generating the plurality of shots of the digital video includes removing noise from the sequence of noise tokens.

10. The method of claim 1, wherein the plurality of shots are associated with a same foreground subject, and wherein the one or more text prompts indicate at least one of a duration of respective shots of the plurality of shots or a numerical quantity of shots in the digital video.

11. A computing device comprising:
a processing device; and
a computer-readable storage medium storing instructions that, responsive to execution by the processing device, causes the processing device to perform operations including:
receiving one or more text prompts describing a plurality of shots in a digital video;
generating the digital video using a machine learning model based on a sequence of tokens as corresponding to the plurality of shots and a transition token corresponding to a transition between the plurality of shots; and
presenting the digital video for display in a user interface.

12. The computing device of claim 11, wherein respective shots of the plurality of shots include one or more attributes that satisfy a first threshold rate of change of motion within the respective shots, wherein the one or more attributes include one or more of a foreground subject of the respective shots, a background of the respective shots, an action of the foreground subject of the respective shots, or a capture perspective of the respective shots, and wherein the respective shots are separated based on the one or more attributes satisfying a second threshold rate of change of motion across the respective shots.

13. The computing device of claim 11, wherein the generating the digital video includes:
generating the transition token based on one or more vector embeddings that indicate the transition between the plurality of shots, wherein the transition between the plurality of shots is based on the one or more text prompts; and
applying, based on the transition token, an attention mask to groups of tokens of the sequence of tokens, wherein the groups of tokens correspond to respective shots of the plurality of shots.

14. The computing device of claim 11, further comprising:
generating training data based on one or more of parsing a first set of digital videos including respective single shots to obtain a second set of digital videos including respective shots or combining a third set of digital videos associated with a same foreground subject, wherein respective digital videos of the third set of digital videos include a single shot;
obtaining, from one or more of the second set of digital videos or the third set of digital videos, one or more additional text prompts, wherein the training data includes one or more of the second set of digital videos, the third set of digital videos, or the one or more additional text prompts; and
updating, based on the training data, one or more parameters of the machine learning model to cause the machine learning model to generate the digital video from the one or more text prompts.

15. The computing device of claim 11, wherein the generating the digital video includes:
providing the sequence of tokens as input to the machine learning model; and
obtaining, as output from the machine learning model, the plurality of shots of the digital video.

16. The computing device of claim 11, further comprising transmitting, to the processing device, an indication of parameters representative of the machine learning model, wherein the machine learning model is a diffusion transformer model.

17. The computing device of claim 11, wherein the sequence of tokens includes a sequence of noise tokens, and wherein generating the plurality of shots of the digital video includes removing noise from the sequence of noise tokens.

18. One or more computer-readable storage media storing instructions that, responsive to execution by a processing device, cause the processing device to perform operations comprising:
obtaining a plurality of portions from one or more source digital videos;
generating a plurality of training digital videos based on the plurality of portions from the one or more source digital videos, wherein respective training digital videos of the plurality of training digital videos are generated to include multiple shots; and
training a machine-learning model based on the plurality of training digital videos.

19. The one or more computer-readable storage media of claim 18, wherein at least one training digital video of the plurality of training digital videos is generated from a single source digital video filtered from the one or more source digital videos having a single shot based on an amount of motion exhibited by the single source digital video.

20. The one or more computer-readable storage media of claim 18, wherein at least one training digital video of the plurality of training digital videos is generated by selecting the plurality of portions from a plurality of source digital videos.
